(19) United States
(12) Patent Application Publication
(10) Pub. No.: US 2009/0060706 A1
(43) Pub. Date: Mar. 5, 2009

(54) BALL BEARING AND PUMP FOR CRYOGENIC USE

(75) Inventor: Alex Habibvand, Orange, CA (US)

Correspondence Address: MICHAUD-DUFFY GROUP LLP, 306 INDUSTRIAL PARK ROAD, SUITE 206, MIDDLETOWN, CT, 06457, US

(73) Assignee: Roller Bearing Company of America, Inc, Oxford, CT (US)

(21) Appl. No.: 12/204,886

(22) Filed: Sep. 5, 2008

Related U.S. Application Data
(60) Provisional application No. 60/967,540, filed on Sep. 5, 2007.

(51) Int. Cl. F04D 29/04; F16C 19/50

(52) U.S. Cl. 415/1; 384/447; 415/229

(57) ABSTRACT

A ball bearing for use in cryogenic applications has an inner ring and an outer ring that define a raceway between them, and there is a set of rolling balls in the raceway with slug ball separators between adjacent rolling balls. The bearing may be used in a pump for cryogenic fluids such as LNG, LOX, LH2, etc.

### CROSS-REFERENCE TO RELATED APPLICATIONS

This application claims the benefit of U.S. provisional application No. 60/967,540 filed Sep. 5, 2007, which is incorporated herein by reference.

### FIELD OF THE INVENTION

This invention relates to ball bearings and in particular to ball bearings used in cryogenic applications.

### BACKGROUND

Ball bearings used in cryogenic applications have to function at temperatures of about −130° C. to about −270° C. (about −200° F. to about −450° F.). For example, such ball bearings are used in pumps that are submerged in liquefied natural gas (LNG), or in turbo-pumps of rocket engines burning liquid hydrogen (LH2) with liquid oxygen (LOX). The bearings comprise balls held in place by cages and normally run at high speeds and carry significant loads.

The robustness of a ball bearing is significantly reduced in cryogenic applications relative to the performance of the ball bearing at room temperature. For example, materials can become quite brittle in cryogenic applications, necessitating a variety of design reinforcement measures such as the addition of metallic shrouds, side plates, riveting, etc, when one-piece cage designs are used. A common failure mode of ball bearings in cryogenic applications is failure of the bearing cage. The significant differences between the coefficient of thermal contraction (CTC) of metallic bearing rings, metallic cage reinforcement components, and non-metallic cage materials further adds to the complexity of designing a bearing for cryogenic use.

Pumps used for cryogenic aerospace applications, and the bearings therein, are not only subject to the severity of cryogenic temperatures, but also to limitations on pump weight. In addition, no active lubrication of the bearings in the usual sense is available or feasible. One lubrication effect provided to a bearing in such a pump, if any, is often limited to the result of a bypass flow of the cryogenic fluid (for example, LNG, LH2 or LOX) through the bearing.

Beside the cryogenic fluid itself, a bearing cage material can serve as a source of limited “transfer lubrication” in cryogenic bearings. Cage materials made from Teflon®-based composite materials such as Armalon™ and Rulon™ have been used in severe cryogenic applications. In relatively less severe applications, such as pumping LNG, phenolic composites have been employed as materials for cages, with mixed results.

Ball bearings with small slug ball separators are known for use in bearings for non-cryogenic applications.

It is an object of this invention to provide a cryogenic bearing (that is, a bearing for cryogenic applications) that improves upon prior art cryogenic bearings.

### SUMMARY OF THE INVENTION

The present invention resides in one aspect in an improved ball bearing for cryogenic applications. The bearing has an inner ring and an outer ring, the inner ring and the outer ring defining a raceway between them. A set of rolling balls is positioned in the raceway. Slug separators are positioned between adjacent rolling balls.

The present invention resides in another aspect in an improved pump operable with a cryogenic fluid. The pump comprises a housing having an inlet and an outlet for a fluid and an impeller rotatably mounted and supported in the housing by a pair of ball bearings. Each ball bearing comprises an inner ring and an outer ring, which define a raceway between them. There is a set of rolling balls in the raceway, and there are slug separators are positioned between adjacent rolling balls.

The present invention resides in still another aspect in a method for pumping a fluid under cryogenic conditions, by using a pump as described herein.

### BRIEF DESCRIPTION OF THE DRAWINGS

FIG. 1 is a schematic plan view of a Conrad-type (deep-groove) cryogenic ball bearing for use in a pump as described herein;

FIG. 2 is a partial, cross-sectional view of the ball bearing of FIG. 1; and

FIG. 3 is a schematic view of the bearing of FIG. 1 in a pump for a cryogenic fluid.

### DETAILED DESCRIPTION OF THE INVENTION

This invention provides an improvement to a ball bearing for cryogenic applications, for example, for use in pumps that pump cryogenic fluids. According to this invention, the ball bearing does not employ a cage to separate the rolling balls in the bearing. Instead, the bearing comprises slug ball separators between adjacent rolling balls. As a result of using slug ball separators instead of a cage, a ball bearing meeting the same design constraints as a caged ball bearing can employ larger balls thus significantly increased dynamic load rating and fatigue life. Optionally, the slug ball separators may be individually fitted between adjacent rolling balls in the bearing.

The slug ball separators orbit in the bearing independently and are not in a fixed position with respect to each other as is the case for ball pockets in conventional one-piece ball cages. Slug ball separators are temperature-compliant due to lack of any mating of nonmetallic to metallic parts, whereas conventional one-piece cages present problems caused by differences in CTC between metallic and nonmetallic cage reinforcements. Slug ball separators are also dynamically compliant and, relative to other kinds of spacers, cages or the like, are minimally resistant to lead-and-lag motions in bearings as the rolling balls roll in and out of loaded zones in the bearing. At high speeds, slug ball separators simply float between adjacent rolling balls. In contrast, one-piece cages are dynamically less compliant and must be designed with enough strength to withstand varying dynamic forces in the bearing while rotating as a single piece.

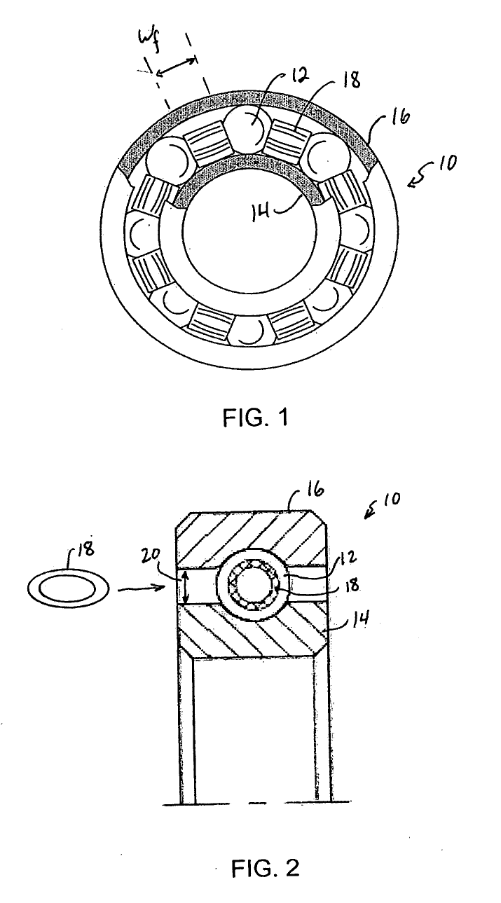

One embodiment of a ball bearing for use in a cryogenic application is shown in FIG. 1 and FIG. 2. The ball bearing 10 (a “cryogenic ball bearing”) comprises rolling balls 12 that are in a raceway defined by an inner ring 14 and outer ring 16. The rolling balls 12 are separated from each other by slug ball separators 18.

In a particular embodiment, slug ball separators 18 are larger than slug ball separators used in ball bearings for non-cryogenic applications. For example, each slug ball separator 18 has an axial length W_{f} measured from end to end. The axial length that may be about equal to the diameter of the balls, or larger than the ball diameter, for example W_{f} might be one or two times the ball diameter. The diameter of the slug ball separator 18, however, is less than the ball diameter.

A slug ball separator for use in a cryogenic ball bearing may be cut from a tubular stock of material made from a synthetic polymeric material such as bearing grade PTFE (polytetrafluoroethylene) (such as TEFLON®), polyamide (Nylon), Rulon™ PTFE compounds, PFA (perfluoroalkoxyethylene), etc.

In a particular embodiment, a cryogenic ball bearing is a Conrad-type (deep-groove) bearing.

The material of the tube stock is selected so that the separators 18 are resilient at ambient temperatures. The separators 18 can therefore be compressed radially and will regain a circular cross-sectional configuration after the compression force is removed. When a Conrad-type bearing 10 is being assembled at ambient temperatures, the separators 18 can be compressed radially into an oval cross-sectional shape. So compressed, the separators can be inserted through the gap 20 between the inner ring 14 and the outer ring 16 of the bearing for placement between adjacent rolling balls 12, as indicated in FIG. 2. Therefore, there is no need to chamfer either the inner ring 14 and/or the outer ring 16 to accommodate the insertion of a cage in the raceway. Accordingly, the cryogenic ball bearing 10 is stronger than a comparative prior art, caged bearing having like dimensions. Another advantage of ball bearing 10 over prior art caged bearings is that the slug ball separators orbit and flow with minimal resistance to lead-and-lag motions of rolling balls 12 as bearing 10 rotates. These advantages are achieved without impact on bearing features such as contact angle, pitch diameter and the number of balls in the bearing.

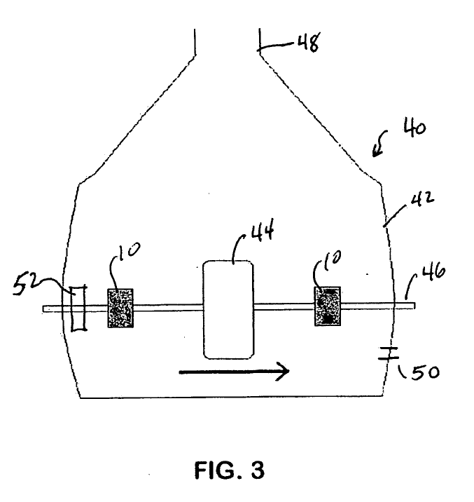

FIG. 3 illustrates a pump 40 that comprises a housing 42. The housing 42 encloses an impeller 44 that is mounted on an axle 46. The axle 46 is supported in the housing 42 by two bearings 10 as described herein, to facilitate rotation of the impeller 44 in the housing 42 even at cryogenic temperatures. The housing 42 also defines an inlet 48 and an outlet 50 to accommodate flow of a cryogenic fluid through the housing 42 so that the rotation of the impeller 44 can generate a fluid flow through the housing. A motor 52 rotates the impeller 44 by rotating the axle 46. The motor 52 may optionally be disposed in the housing 42, as shown, but in other embodiments, a motor may be positioned outside the housing. An output flow conduit can be attached to the outlet 50 so that the pump 40 can deliver the cryogenic fluid to a desired location via the output flow conduit.

The pump 40 may be a submersible pump and be submerged in a cryogenic fluid to draw fluid into the inlet 48 so that the pump 40 can flow the fluid to the outlet 50. Alternatively, the pump 40 may comprise a turbo-pump or another kind of non-submerged pump.

The bearings 10 work in the pump 40 at cryogenic temperatures, optionally without design reinforcement measures such as the addition of metallic shrouds, side plates, riveting, etc.

The terms “first,” “second,” and the like, herein do not denote any order, quantity, or importance, but rather are used to distinguish one element from another. In addition, the terms “a” and “an” herein do not denote a limitation of quantity, but rather denote the presence of at least one of the referenced item.

Although the invention has been described with reference to particular embodiments thereof, it will be understood by one of ordinary skill in the art, upon a reading and understanding of the foregoing disclosure, that numerous variations and alterations to the disclosed embodiments will fall within the spirit and scope of this invention and of the appended claims.

What is claimed is:

1. An improved ball bearing for a cryogenic application, the bearing comprising an inner ring, an outer ring, the inner ring and the outer ring defining a raceway between them; and a set of rolling balls in the raceway, the improvement comprising slug separators between adjacent rolling balls.

2. The ball bearing of claim 1 wherein the slug ball separators are sufficiently resilient at room temperature to permit their insertion into the bearing through a gap between the rings.

3. The ball bearing of claim 1 wherein the slug separators are formed from material comprising bearing grade PTFE, polyimide, polyamide (Nylon), or PFA.

4. The ball bearing of claim 3 wherein the slug ball separators are sufficiently resilient at room temperature to permit their insertion into the bearing through a gap between the rings.

5. The ball bearing of claim 1 wherein the axial length of a slug is at least about equal to the ball diameters.

6. A pump for a cryogenic fluid, the pump comprising:
a housing having an inlet and an outlet for a fluid; and
an impeller rotatably mounted in the housing by a pair of ball bearings;
wherein each the ball bearing comprises an inner ring and an outer ring that define a raceway between them, a set of rolling balls in the raceway; and slug separators between adjacent rolling balls.

7. The pump of claim 6 wherein the slug ball separators are sufficiently resilient at room temperature to permit their insertion into the bearing through a gap between the rings.

8. The pump of claim 6 wherein the slug separators are formed from material comprising bearing grade PTFE, polyamide (nylon), or PFA.

9. The pump of claim 8 wherein the slug ball separators are sufficiently resilient at room temperature to permit their insertion into the bearing through a gap between the rings.

10. The pump of claim 6 wherein the axial length of a slug is at least about equal to the ball diameters.

11. The pump of claim 6, further comprising a motor for rotating the impeller.

12. A method for pumping a fluid under cryogenic conditions, comprising pumping the fluid using a pump according to claim 6.

13. The method of claim 12 wherein the slug ball separators are sufficiently resilient at room temperature to permit their insertion into the bearing through a gap between the rings.

14. The method of claim 12 wherein the slug separators are formed from material comprising bearing grade PTFE, polyimide, polyamide (nylon), or PFA.

15. The method of claim 14 wherein the slug ball separators are sufficiently resilient at room temperature to permit their insertion into the bearing through a gap between the rings.

16. The method of claim 12, wherein the fluid comprises LGN, LOX or LH2.

17. The method of claim 12, wherein the pump is submerged in the liquid.
